(19) United States
(12) Patent Application Publication
(10) Pub. No.: US 2020/0288030 A1
(43) Pub. Date: Sep. 10, 2020

(54) IMAGE INSPECTION APPARATUS, IMAGE INSPECTION METHOD, AND IMAGE INSPECTION PROGRAM

(71) Applicant: Konica Minolta, Inc., Tokyo (JP)

(72) Inventor: Yasumasa Tsukamoto, Tokyo (JP)

(73) Assignee: Konica Minolta, Inc., Tokyo (JP)

(21) Appl. No.: 16/787,884

(22) Filed: Feb. 11, 2020

(30) Foreign Application Priority Data
Mar. 7, 2019 (JP) 2019-041109

(51) Int. Cl. H04N 1/00

(52) U.S. Cl. CPC H04N 1/00816; H04N 1/00803; H04N 1/00326

(57) ABSTRACT

An image inspection apparatus includes: a central processing unit (CPU) that inspects an image obtained by reading a printing paper after image formation in which an original image is laid out on the printing paper and an image is formed by an image forming apparatus, obtain a printing area of the original image on the printing paper, designates an inspection exclusion area on the printing paper, and in response to a change in the printing area of the original image on the printing paper, changes the inspection exclusion area on the printing paper based on the change in the printing area.

### CROSS-REFERENCE TO RELATED APPLICATIONS

This application claims priority from Japanese patent Application No. 2019-041109 filed on Mar. 7, 2019, the entire contents of which are incorporated herein by reference.

### TECHNICAL FIELD

The present invention relates to an image inspection apparatus, an image inspection method, and an image inspection program, and especially relates to an image inspection apparatus which inspects a read image obtained by reading an original image formed on printing paper, an image inspection method using the image inspection apparatus, and an image inspection program which operates on the image inspection apparatus.

### BACKGROUND

In an image forming apparatus such as multi-functional peripherals (MFP), image noise such as streaks or spots might occur in an original image on paper, or color reproducibility or printing position accuracy might be deteriorated. Therefore, image inspection of the paper after image formation is performed using an image inspection apparatus. In this image inspection, the original image formed on the paper is read and compared with a reference image to inspect whether the image noise occurs or to inspect whether color or printing position are shifted.

Regarding such image inspection, for example, JP 10-269359 A discloses an inspection method of importing a picture of a printed matter from a detector (image input unit) for each pixel and detecting dirt, a missing part, an error in character and the like of the printed matter while comparing detected picture information for each pixel with a corresponding reference picture signal for each pixel input in advance, the method provided with (1) a step of storing an image of an inspection sample as a reference in a reference memory, (2) a step of setting an inspection area and a non-inspection area in a mask memory having an address corresponding to the reference memory, (3) a step of storing an image of an inspected printed matter in an image memory, (4) a step of correcting a position of recording information of the inspected image memory for comparison with the reference memory, (5) a step of ignoring a pixel corresponding to the non-inspection area set in the mask memory out of defect candidate pixels extracted as a result of comparison with the reference memory signal even when a defect is detected, and (6) a step of displaying a difference image and determining as waste paper only in a case where the number of pixels of different points in the inspection area is larger than a set threshold.

In the image inspection, an entire area on the paper is subject to the image inspection, but it is possible to efficiently perform the image inspection by excluding in advance an area such as a variable area (variable area) in which printing contents are different from paper to paper and an area which is likely to be determined as defective in the inspection such as a paper edge from the image inspection target. For example, JP 10-269359 A has a function of designating an area to be excluded from the inspection (hereinafter referred to as an inspection exclusion area) in printed paper; the inspection is not performed in the designated area, and even if the reference image does not conform to the inspection image, this is not determined as inspection abnormal.

However, in the conventional art, the inspection exclusion area is designated for the printed paper (that is, designated with reference to a corner of the paper), so that when reprinting is performed (at the time of reprinting), in a case where the layout of the original image in the paper is changed or an image formation condition (for example, paper size) is changed, a position of the inspection exclusion area with respect to the paper is shifted. As a result, the inspection exclusion area has to be designated again at the time of reprinting, and the operation becomes complicated.

### SUMMARY

One or more embodiments of the present invention provide an image inspection apparatus, an image inspection method, and an image inspection program capable of performing an image inspection on an appropriate area even in a case where a layout of the original image is changed or an image forming condition is changed at the time of reprinting.

One or more embodiments of the present invention provide an image inspection apparatus provided with a central processing unit (CPU) that inspects an image obtained by reading printing paper after image formation in which an original image is laid out on the printing paper and an image is formed by an image forming apparatus, wherein the CPU obtains a printing area of the original image on the printing paper, designates an inspection exclusion area on the printing paper, and in a case where the printing area of the original image on the printing paper is changed (i.e., in response to a change in the printing area of the original image on the printing paper), changes the inspection exclusion area on the printing paper based on the change in the printing area.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIGS. 1A to 1C are schematic diagrams for illustrating an inspection exclusion area designated by a designation method according to one or more embodiments of the present invention;

FIGS. 2A and 2B are schematic diagrams for illustrating the inspection exclusion area designated by the designation method according to one or more embodiments of the present invention;

FIGS. 3A and 3B are schematic diagrams for illustrating the inspection exclusion area designated by the designation method according to one or more embodiments of the present invention;

FIG. 4 is a schematic diagram illustrating a configuration of an image inspection system according to an example 1 of the present invention;

FIG. 5 is a block diagram illustrating a configuration of an image forming apparatus in the image inspection system according to the example 1 of the present invention;

FIG. 6 is a block diagram illustrating a configuration of an image inspection apparatus in the image inspection system according to the example 1 of the present invention;

FIG. 7 is a schematic diagram illustrating a process of the image inspection apparatus according to the example 1 of the present invention;

FIGS. 8A and 8B are schematic diagrams for illustrating a method of designating an inspection exclusion area according to the example 1 of the present invention;

FIG. 9 is a schematic diagram for illustrating an effect of the method of designating the inspection exclusion area according to the example 1 of the present invention;

FIG. 10 is a schematic diagram for illustrating the effect of the method of designating the inspection exclusion area according to the example 1 of the present invention;

FIG. 11 is a schematic diagram for illustrating the method of designating the inspection exclusion area according to the example 1 of the present invention;

FIGS. 12A and 12B are relationship diagrams for illustrating job information according to the example 1 of the present invention as compared with that in the conventional art;

FIG. 13 is a relationship diagram of job information according to the example 1 of the present invention;

FIGS. 14A and 14B are relationship diagrams of the method of designating an inspection exclusion area according to the example 1 of the present invention;

FIG. 15 is a flowchart illustrating operation of the image inspection apparatus according to the example 1 of the present invention;

FIG. 16 is a flowchart illustrating an operation (correct image generating process) of the image inspection apparatus according to the example 1 of the present invention;

FIG. 17 is a flowchart illustrating an operation (inspection exclusion area designating process) of the image inspection apparatus according to the example 1 of the present invention;

FIG. 18 is a flowchart illustrating an operation (image inspecting process) of the image inspection apparatus according to the example 1 of the present invention;

FIG. 19 is a flowchart illustrating an operation (inspection exclusion area changing process) of the image inspection apparatus according to the example 1 of the present invention;

FIG. 20 is a schematic diagram illustrating a process of an image inspection apparatus according to an example 2 of the present invention;

FIGS. 21A and 21B are schematic diagrams for illustrating a method of designating an inspection exclusion area according to the example 2 of the present invention;

FIG. 22 is a relationship diagram of job information according to the example 2 of the present invention;

FIG. 23 is a schematic diagram for illustrating the method of designating the inspection exclusion area according to the example 2 of the present invention;

FIG. 24 is a schematic diagram for illustrating the method of designating the inspection exclusion area according to the example 2 of the present invention;

FIG. 25 is a flowchart illustrating an operation (correct image generating process) of the image inspection apparatus according to the example 2 of the present invention;

FIG. 26 is a flowchart illustrating an operation (inspection exclusion area designating process) of the image inspection apparatus according to the example 2 of the present invention;

FIG. 27 is a flowchart illustrating an operation (image inspecting process) of the image inspection apparatus according to the example 2 of the present invention;

FIG. 28 is a flowchart illustrating an operation (inspection exclusion area changing process) of the image inspection apparatus according to the example 2 of the present invention;

FIGS. 29A and 29B are schematic diagrams for illustrating variable printing;

FIGS. 30A and 30B are schematic diagrams for illustrating a conventional method of designating an inspection exclusion area;

FIG. 31 is a schematic diagram for illustrating the conventional method of designating the inspection exclusion area; and

FIG. 32 is a schematic diagram for illustrating the conventional method of designating the inspection exclusion area.

### DETAILED DESCRIPTION

Hereinafter, one or more embodiments of the present invention will be described with reference to the drawings. However, the scope of the invention is not limited to the disclosed embodiments.

As illustrated in the description of the related art, with an image forming apparatus, image noise such as streaks or spots might occur in an image on paper, and color reproducibility and printing position accuracy might be deteriorated, so that image inspection is performed by reading the image formed on the paper and comparing the same with a reference image.

At that time, it is possible to efficiently perform the image inspection by excluding in advance a variable area in which printing contents are different from paper to paper and a paper edge area which is likely to be determined to be defective in the inspection from an image inspection target; if an inspection exclusion area is designated for printed paper as in the conventional art, the inspection exclusion area must be designated again in a case of reprinting after changing a layout and a paper size of an original image in the paper, so that operation becomes complicated.

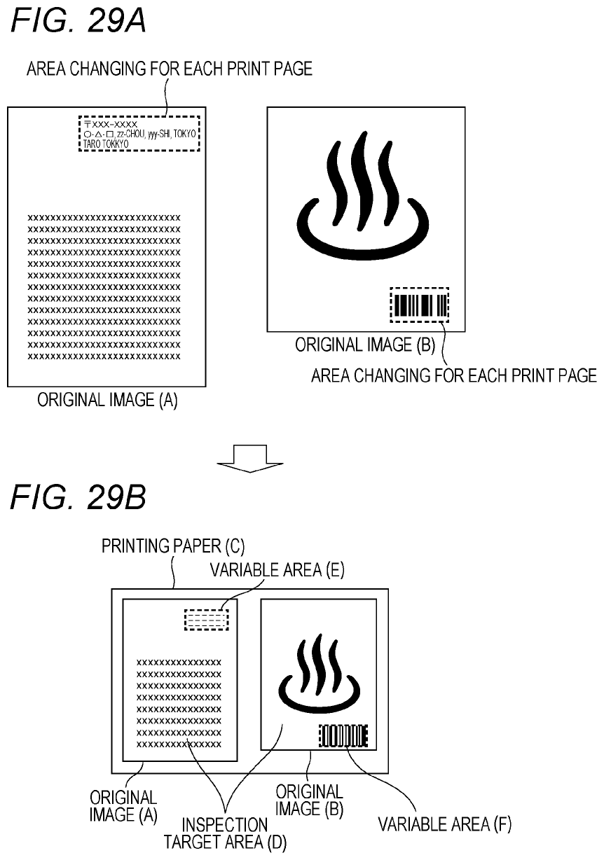

As illustrated in FIGS. 29A and 29B, original images (A) and (B) are printed on printing paper (C). As illustrated in FIG. 29A, the original image (A) includes a destination such as an address and a name, and the original image (B) includes an area which changes for each print page such as a barcode, a so-called variable area, so that unless the reference image serving as a reference for determination of the image inspection is prepared for each print page, mismatch occurs at the time of image inspection, and this is determined as inspection abnormal. Therefore, as illustrated in FIG. 29B, it is necessary to exclude variable areas (E) and (F) from the image inspection target and perform the image inspection on an area other than the variable areas as an inspection target area (D).

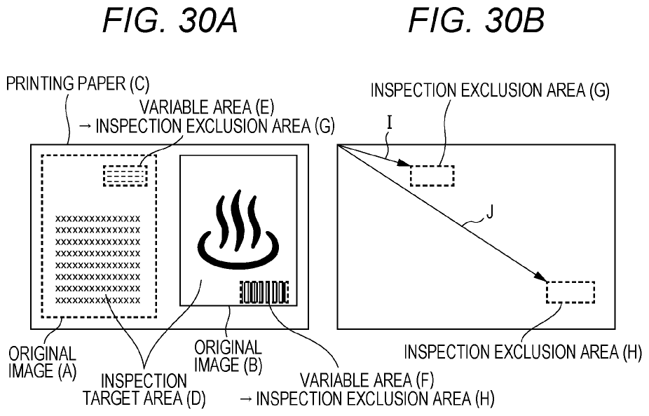

Then, in JP 10-269359 A, as illustrated in FIG. 30A, a function of designating a destination field (variable area (E)) and a bar code field (variable area (F)) as inspection exclusion areas (G) and (H), respectively, as areas to be excluded from the image inspection target, and the image inspection is not performed in the designated area and even when the reference image and the inspection image do not conform to each other in the area, this is not determined as inspection abnormal. At that time, in the conventional art, as illustrated in FIG. 30B, the designated inspection exclusion areas (G) and (H) are stored in association with an image obtained by reading the printed paper (stored as offset positions (I) and (J) from an upper left corner of the image obtained by reading the printed paper).

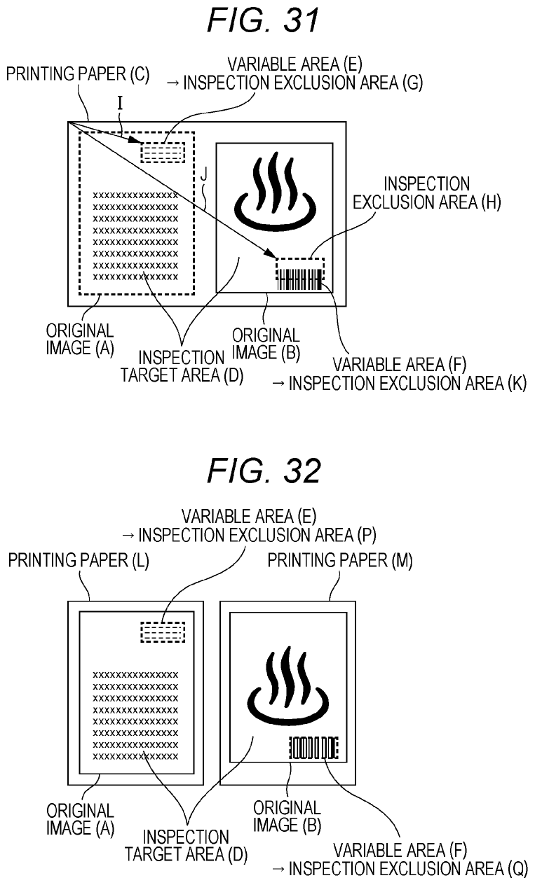

Herein, as illustrated in FIG. 31, in a case where a layout of the original image (B) in the paper is changed (moved downward in the drawing) when reprinting or the like, the position of the barcode field (variable area (F)) changes; however, a position of the inspection exclusion area (H) does not change because this is associated with the paper as the offset position (J) from the upper left corner of the image obtained by reading the printed paper. Therefore, the barcode field (variable area (F)) cannot be excluded from the image inspection target unless the designation of the inspection exclusion area (H) is deleted and the inspection exclusion area (K) is newly designated.

If the inspection exclusion area is not changed, the barcode field (variable area (F)) in which the printing contents are different for each print page is determined as inspection abnormal in the image inspection. Apart of the inspection exclusion area (H) is designated as the inspection exclusion area even though this is not the variable area, so that even when there is abnormality such as dirt in this part of the inspection exclusion area (H), this is not detected.

As illustrated in FIG. 32, also in a case where a size of paper on which the original images (A) and (B) are printed is changed (to printing paper (L) and printing paper (M)), inspection exclusion areas (P) and (Q) should be newly set for the destination field (variable area (E)) and the barcode field (variable area (F)), respectively, so that a situation similar to that described above arises unless the inspection exclusion area is changed.

Therefore, in one or more embodiments of the present invention, a trouble of designating the inspection exclusion area again in a case where the layout position on the printing paper of the original image and the printing paper size are changed at the time of reprinting is eliminated. Specifically, an image inspection apparatus which inspects the image obtained by reading the printing paper after the image formation in which the original image is laid out on the printing paper and the image is formed by the image forming apparatus is provided with a printing area obtainer which obtains a printing area of the original image on the printing paper, an inspection exclusion area designator which designates the inspection exclusion area on the printing paper, and an inspection exclusion area calculator which changes the inspection exclusion area on the printing paper based on a change in the printing area in a case where the printing area of the original image on the printing paper is changed.

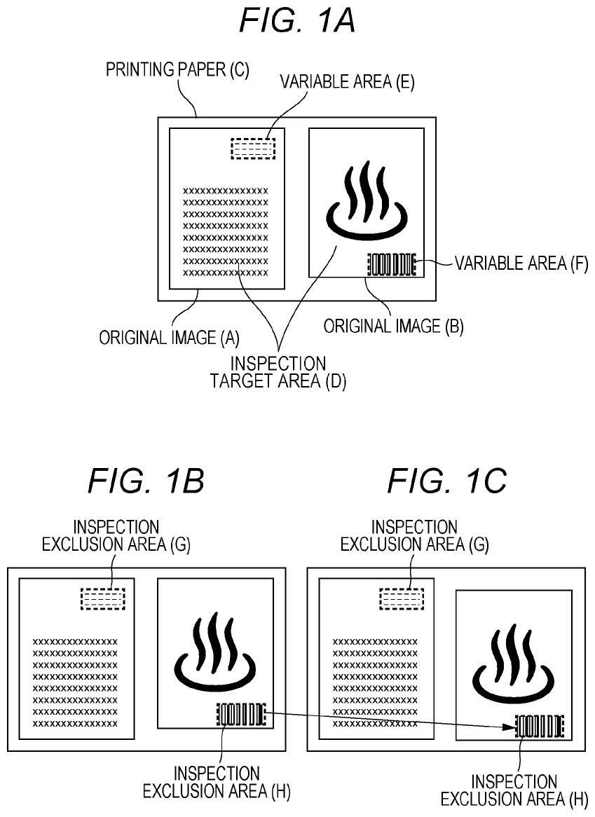

Hereinafter, a method of designating the inspection exclusion area according to one or more embodiments of the present invention is schematically described with reference to FIGS. 1A to 3B. As illustrated in FIGS. 1A to 1C, when the original images (A) and (B) are printed on the printing paper (C), the destination field (variable area (E)) and the barcode field (variable area (F)) are designated as the inspection exclusion areas (G) and (H), respectively, and it is not determined as inspection abnormal even when the reference image and the inspection image do not conform to each other within the areas. At that time, in one or more embodiments, the inspection exclusion area is not designated based on the printing paper but is designated based on the original image or the printing area of the original image.

As a result, as illustrated in FIGS. 1B and 1C, for example, in a case where the layout position on the printing paper of the original image (B) is changed, the inspection exclusion area (H) may be automatically moved based on a difference between the printing area (layout position) of the original image (B) before the change and the printing area (layout position) of the original image (B) after the change, so that it is possible to improve convenience for a user by eliminating operation such as deletion of the inspection exclusion area before the change and new addition of the inspection exclusion area.

For example, the inspection exclusion area after the change may be obtained by the following equation. Note that the printing area of the original image is intended to mean an area determined by printing position coordinates (upper left) of the original image on the printing paper, and a size in a main-scanning direction and in a sub-scanning direction of the original image.

Inspection exclusion area after change=inspection exclusion area before change+{printing area(layout position)of original image after change−printing area(layout position)of original image before change} (1)

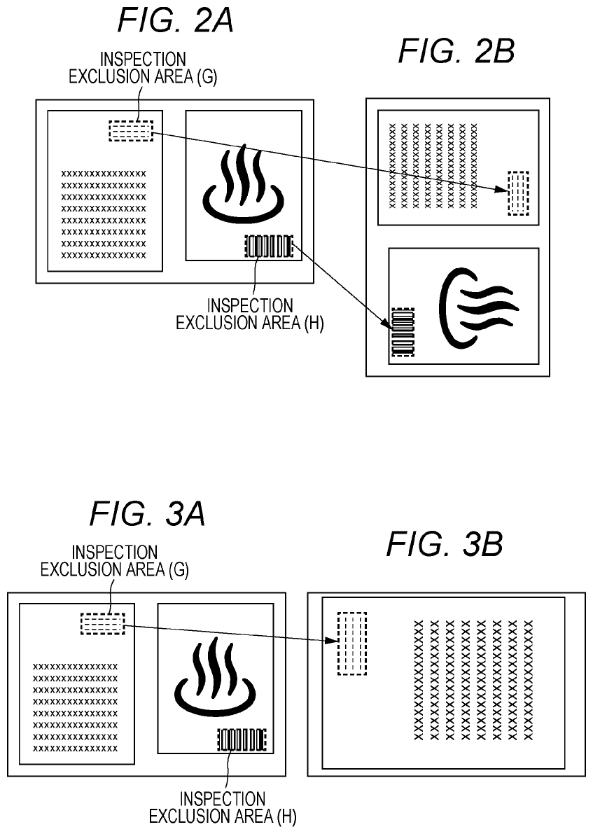

In a case where the printing paper size is changed, where the original image is rotated to be printed on paper with different orientation as illustrated in FIGS. 2A and 2B, or where the original image is enlarged (or contracted) to be printed as illustrated in FIGS. 3A and 3B, it is possible to automatically change the inspection exclusion area based on the difference before and after the change of the printing area (layout position) of the original image on the printing paper, and it is possible to improve the convenience for the user by eliminating the operation of deleting the inspection exclusion area before the change and newly adding the inspection exclusion area.

### EXAMPLE 1

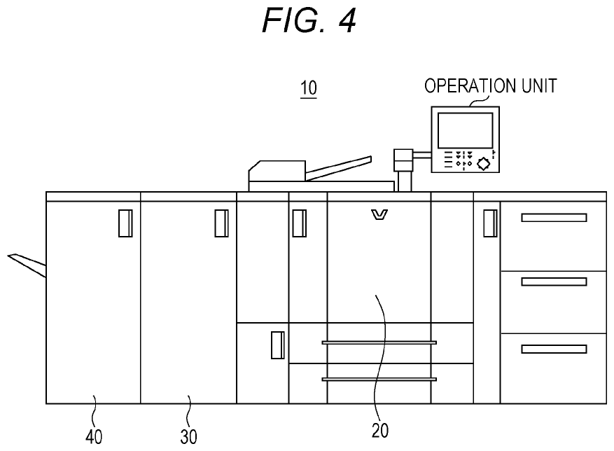

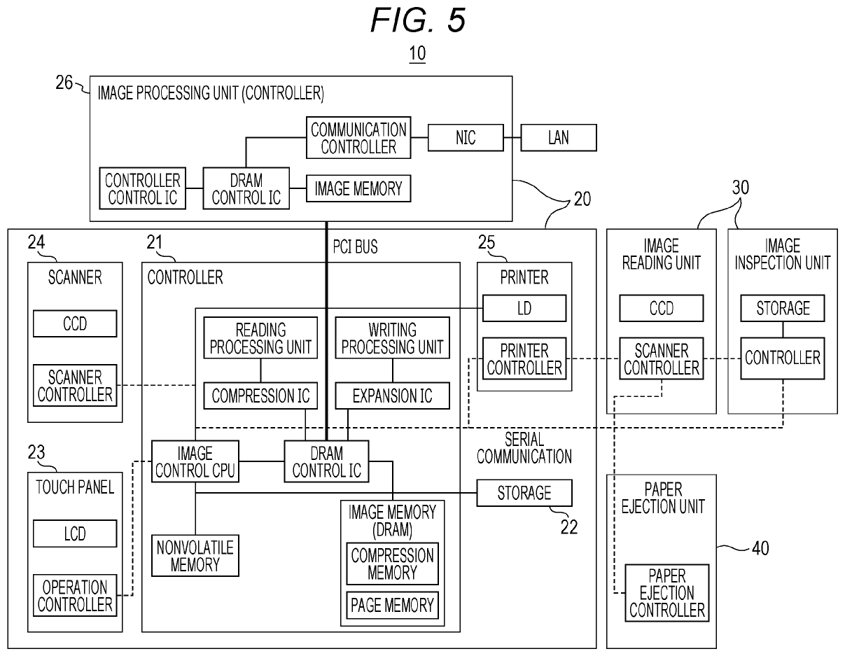

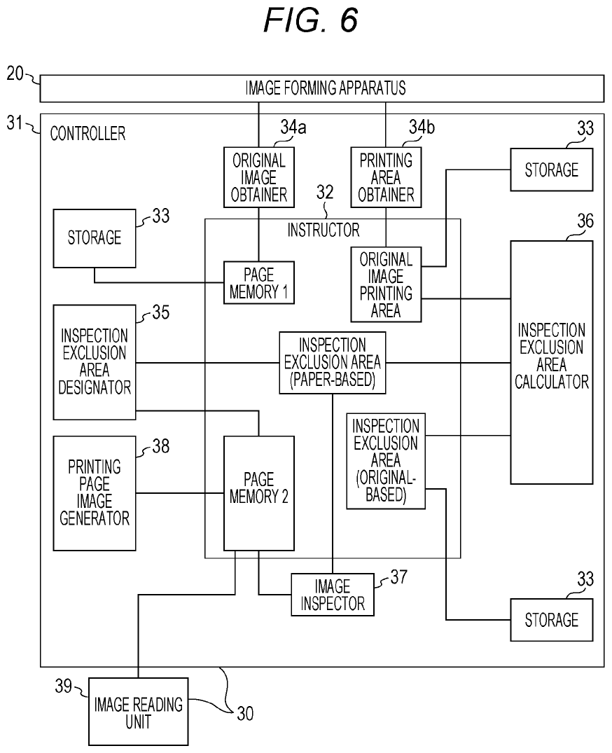

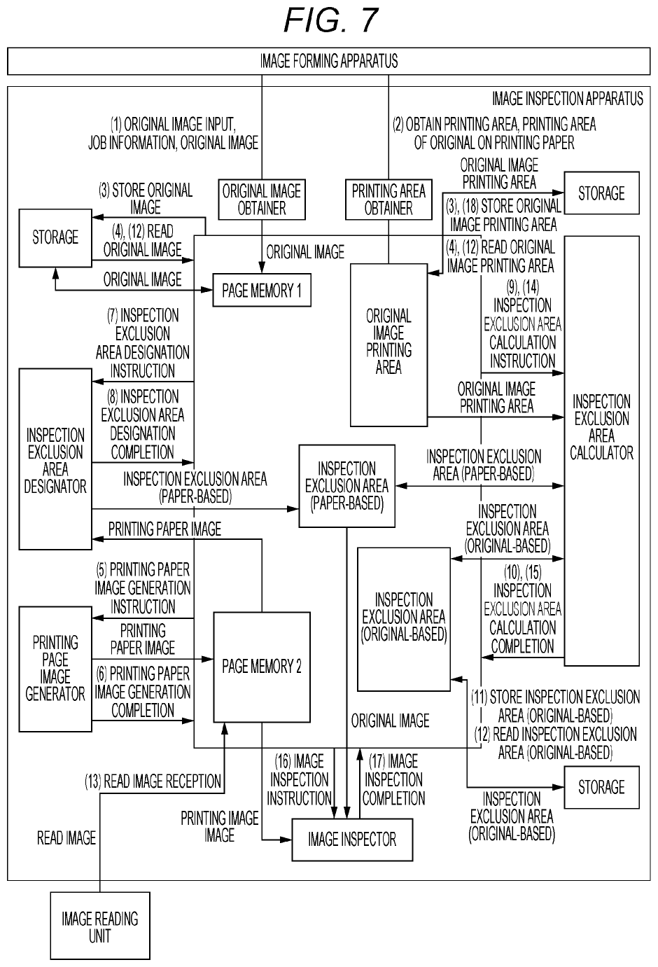

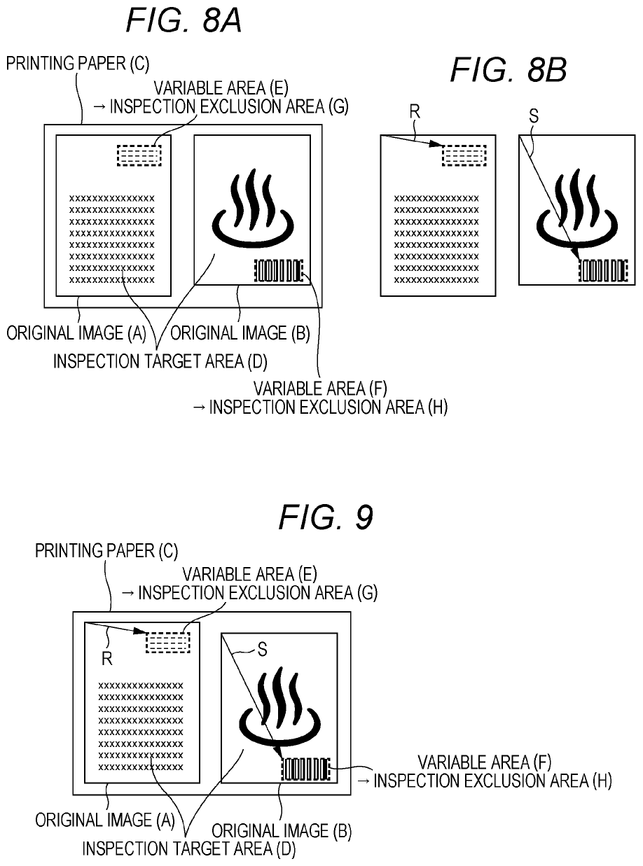

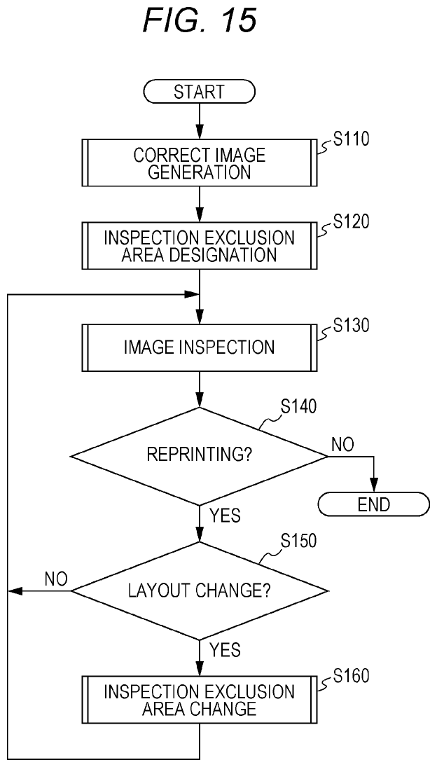

In order to describe one or more embodiments of the present invention described above in more detail, an image inspection apparatus, an image inspection method, and an image inspection program according to an example 1 of the present invention are described with reference to FIGS. 4 to 19. FIG. 4 is a schematic diagram illustrating a configuration of the image inspection system according to this example, and FIG. 5 is a block diagram illustrating a configuration of the image forming apparatus in an image inspection system. FIG. 6 is a block diagram illustrating a configuration of the image inspection apparatus in the image inspection system, and FIG. 7 is a schematic diagram illustrating processes of the image inspection apparatus. FIGS. 8A to 14B are schematic diagrams for illustrating a method of designating an inspection exclusion area according to this example, and FIGS. 15 to 19 are flowcharts illustrating operation of the image inspection apparatus according to this example.

As illustrated in FIG. 4, an image inspection system 10 of this example includes an image forming apparatus 20 which forms an original image on printing paper, an image inspection apparatus 30 which inspects the original image formed on the printing paper, a paper ejection apparatus 40 which ejects the printing paper after the image inspection and the like.

FIG. 5 is a block diagram illustrating a configuration of the image inspection system 10 of this example (mainly a configuration of the image forming apparatus 20). As illustrated in FIG. 5, the image forming apparatus 20 includes a controller 21, a storage 22, a touch panel 23, a scanner (image reading unit) 24, a printer (image writing unit) 25, an image processing unit 26 and the like. The image inspection apparatus 30 is provided with an image reading unit which reads printing paper on which an image is written by the printer 25 of the image forming apparatus 20, an image inspector which inspects the image read by the image reading unit and the like. The paper ejection apparatus 40 is provided with a paper ejection unit which sorts to eject the printing paper based on a result of the image inspection.

The controller 21 is generally provided with a central processing unit (CPU) and a memory such as a read only memory (ROM) and a random access memory (RAM) connected through a bus. The CPU controls an entire image forming apparatus 20 by reading a program from the ROM and the storage 22 and developing the same on the RAM to execute. In this example, the controller 21 is provided with an image control CPU, a nonvolatile memory, a DRAM control integrated circuit (IC), an image memory (DRAM), an expansion IC, a writing processing unit, a compression IC, a reading processing unit and the like.

The storage 22 is formed of a hard disk drive (HDD), a solid state drive (SSD) and the like, and stores various programs and various pieces of information for the CPU to control each unit.

The touch panel 23 is formed of a display unit such as a liquid crystal display (LCD) and an operation controller which controls an operation unit such as a touch sensor formed of a grid-shaped transparent electrode, and displays various screens and enables various operations on the screen.

The scanner (image reading unit) 24 is a unit which optically reads image data from the original placed on a platen, and is formed of a charge coupled device (CCD) which converts light reflected by the original to electric signals and a scanner controller which controls operation of the CCD and processes the electric signals output from the CCD.

The printer (image writing unit) 25 is an engine which executes a printing process based on the image data; for example, this is formed of a laser diode (LD) which forms an electrostatic latent image by irradiating a charged photosensitive drum with laser light corresponding to an image and a printer controller which performs various controls for actualizing the electrostatic latent image and forming an image on paper.

The image processing unit 26 is connected to the DRAM control IC of the controller 21 via a peripheral components interconnect (PCI) bus, and serves as a controller which performs image processing and controls the scanner 24 and the printer 25. In this example, the image processing unit 26 is provided with a controller control IC, a DRAM control IC, an image memory, a communication controller, a network interface card (NIC) and the like, and establishes connection to another apparatus connected by a communication network such as a local area network (LAN) to receive print data from an external apparatus (for example, a client apparatus), and transmit the image data read by the scanner 24 to the external apparatus by e-mail.

FIG. 6 is a block diagram illustrating the configuration of the image inspection system 10 according to this example (especially, a configuration of the image inspection apparatus 30). The image inspection apparatus 30 of this example is formed of a controller 31, an image reading unit 39 and the like; and the controller 31 is formed of an instruction unit 32, a storage 33, an original image obtainer 34a, a printing area obtainer 34b, an inspection exclusion area designator 35, an inspection exclusion area calculator 36, an image inspector 37, a printing paper image generator 38 and the like.

The controller 31 is generally provided with a CPU and a memory such as a ROM or a RAM, which are connected via a bus. The instruction unit 32 is a unit which instructs each unit as a function of the controller 31; this holds the original image, a printing area of the original image on the printing paper, a read image, a printing paper image, a paper-based inspection exclusion area (inspection exclusion area set based on a predetermined position of the paper), an original-based inspection exclusion area (inspection exclusion area set based on a predetermined position of the original) and the like, and performs an original image input instruction, an inspection exclusion area designation instruction, an inspection exclusion area calculation instruction, an image inspection instruction and the like based on the information.

The storage 33 stores the original image, the printing area of the original image on the printing paper, the inspection exclusion area on the original image, the printing paper image and the like. The storage 33 associates the original image with printing paper information of job information, and associates the original image with the printing area and the inspection exclusion area of the original image on the printing paper to store.

The original image obtainer 34a obtains the original image from the image forming apparatus 20. Note that the original image may also be obtained directly from the image processing unit (controller) 26. The printing area obtainer 34b obtains the printing area of the original image on the printing paper from the image forming apparatus 20.

The inspection exclusion area designator 35 designates the inspection exclusion area on the printing paper on the printing paper image generated by the printing paper image generator 38 to be described later or the read image obtained by reading the printing paper after the image formation by the image reading unit 39. For example, by allowing the display operation unit (for example, a touch panel 23 of the image forming apparatus 20 and the like) in the image inspection system 10 to display the printing paper image or the read image, allowing the user to designate the area and obtaining area, designating operation information from the display operation unit, the inspection exclusion area on the printing paper is designated.

In a case where the printing area of the original image on the printing paper is changed, the inspection exclusion area calculator 36 changes the inspection exclusion area on the printing paper based on the change of the printing area. Specifically, this calculates the inspection exclusion area on the original image based on the printing area of the original image on the printing paper and the inspection exclusion area on the printing paper designated by the inspection exclusion area designator 35, stores the calculated inspection exclusion area on the original image in the storage 33 or the like in association with the original image, and in a case where the printing area of the original image on the printing paper is changed, this calculates the inspection exclusion area on the printing paper based on the inspection exclusion area on the original image stored in the storage 33 or the like and the printing area of the original image on the printing paper obtained after the change by the printing area obtainer 34b. The inspection exclusion area calculator 36 determines whether the inspection exclusion area on the printing paper and the printing area of the original image on the printing paper overlap with each other, and stores the inspection exclusion area on the printing paper which does not overlap with the printing area of the original image on the printing paper in the storage 33 and the like while in association with the printing paper.

The image inspector 37 compares the read image obtained by reading the printing paper after the image formation with an image serving as a determination reference (hereinafter referred to as a correct image) to determine whether the image is excellent (whether an image defect is detected). At that time, the inspection exclusion area on the printing paper designated by the inspection exclusion area designator 35 or the inspection exclusion area on the printing paper calculated by the inspection exclusion area calculator 36 in a case where the printing area of the original image on the printing paper is changed is excluded from the inspection, so that even when the abnormality is detected in the inspection exclusion area on the printing paper, this is not determined as inspection abnormal.

The printing paper image generator 38 generates the printing paper image from the original image and the printing area of the original image on the printing paper.

The image reading unit 39 is an inline scanner or the like which optically reads the image data from the printing paper after the image formation conveyed from the image forming apparatus 20, and is formed of a CCD which converts the light reflected by the original into electric signals and a scanner controller which controls operation of the CCD and processes the electric signals output from the CCD. Note that, in a case where the image forming apparatus 20 is provided with the inline scanner which scans the printing paper after the image formation, an image read by the inline scanner may be made an image inspection target, and in that case, the image reading unit 39 may be omitted.

Next, a process of the image inspection apparatus 30 configured as described above is described with reference to FIG. 7. Note that, FIG. 7 illustrates the process in a case where the original image is the correct image.

<Generation of Correct Image>

(1) The original image obtainer 34a obtains the original image from the image forming apparatus 20. The obtained original image is stored in a page memory 1.

(2) The printing area obtainer 34b obtains the printing area of the original image on the printing paper from the image forming apparatus 20.

(3) The instruction unit 32 stores the original image obtained by the original image obtainer 34a and the printing area of the original image on the printing paper obtained by the printing area obtainer 34b in the storage 33.

<Inspection Exclusion Area Designation>

(4) The instruction unit 32 reads from the storage 33 the original image and the printing area of the original image on the printing paper.

(5) The instruction unit 32 instructs the printing paper image generator 38 to generate the printing paper image.

(6) The printing paper image generator 38 combines the original image in the page memory 1, the printing area of the original image on the printing paper stored in the storage 33, and a background image of the printing paper size obtained in advance to generate the printing paper image, and stores the same in a page memory 2. Then, the printing paper image generator 38 notifies the instruction unit 32 that the printing paper image generation is completed.

(7) The instruction unit 32 instructs the inspection exclusion area designator 35 to designate the inspection exclusion area.

(8) The inspection exclusion area designator 35 designates the inspection exclusion area (paper-based) for the printing paper image generated by the printing paper image generator 38. Then, the inspection exclusion area designator 35 notifies the instruction unit 32 that the inspection exclusion area designation is completed.

(9) The instruction unit 32 instructs the inspection exclusion area calculator 36 to calculate the inspection exclusion area (paper-based).

(10) The inspection exclusion area calculator 36 calculates the inspection exclusion area (original-based) from the inspection exclusion area (paper-based) designated by the inspection exclusion area designator 35 and the printing area of the original image on the printing paper stored in the storage 33. Then, the inspection exclusion area calculator 36 notifies the instruction unit 32 that the inspection exclusion area calculation is completed.

(11) The instruction unit 32 stores the inspection exclusion area (original-based) in the storage 33.

<Image Inspection>

(12) The instruction unit 32 reads from the storage 33 the original image, the printing area of the original image on the printing paper, and the inspection exclusion area (original-based).

(13) The instruction unit 32 receives the read image obtained by reading the printing paper after the image formation from the image reading unit 39 and stores the same in the page memory 2.

(14) The instruction unit 32 instructs the inspection exclusion area calculator 36 to calculate the inspection exclusion area (paper-based).

(15) The inspection exclusion area calculator 36 calculates the inspection exclusion area (paper-based) from the inspection exclusion area (original-based) and the printing area of the original image on the printing paper. Then, the inspection exclusion area calculator 36 notifies the instruction unit 32 that the inspection exclusion area calculation is completed.

(16) The instruction unit 32 instructs the image inspector 37 to inspect the image.

(17) The image inspector 37 performs the image inspection using the original image (page memory 1) and the read image (page memory 2). At that time, the inspection exclusion area (paper-based) calculated by the inspection exclusion area calculator 36 is excluded from the inspection (even when the abnormality is detected in the inspection exclusion area, this is not determined as abnormal). Then, the image inspector 37 notifies the instruction unit 32 that the image inspection is completed.

<Process in Case where Layout of Original Image on Printing Paper is Changed>

(18) The instruction unit 32 stores the printing area of the original image on the printing paper after the change in the storage 33.

Thereafter, the procedure shifts to <Image inspection> and a similar process is performed. At that time, the inspection exclusion area on the printing paper is calculated using the inspection exclusion area (original-based) stored in the storage 33 at (11) of <Inspection exclusion area designation>, so that no process of <Inspection exclusion area designation> is necessary.

Hereinafter, the method of designating the inspection exclusion area according to this example is specifically described with reference to the drawings. When original images (A) and (B) illustrated in FIGS. 1A to 1C are printed on printing paper (C), as illustrated in FIG. 8A, a destination field (variable area (E)) and a barcode field (variable area (F)) are designated as inspection exclusion areas (G) and (H), respectively, as areas excluded from an inspection target. At that time, in this example, as illustrated in FIG. 8B, the designated inspection exclusion areas (G) and (H) are stored in association with the original images (A) and (B), respectively (stored as offset positions (R) and (S) from an upper left corner of the original image).

As a result, as illustrated in FIG. 9, also in a case where the printing area (layout position) in the printing paper of the original image (B) is changed (herein moved downward in the drawing) when reprinting or the like, the inspection exclusion area (H) is associated with the original image as an offset position (S) from the upper left corner of the original image, so that the inspection exclusion area (H) is also changed in conjunction with the position of the barcode field (variable area (F)). Therefore, the barcode field (variable area (F)) may be excluded from the inspection target without deleting the original inspection exclusion area or newly setting the inspection exclusion area.

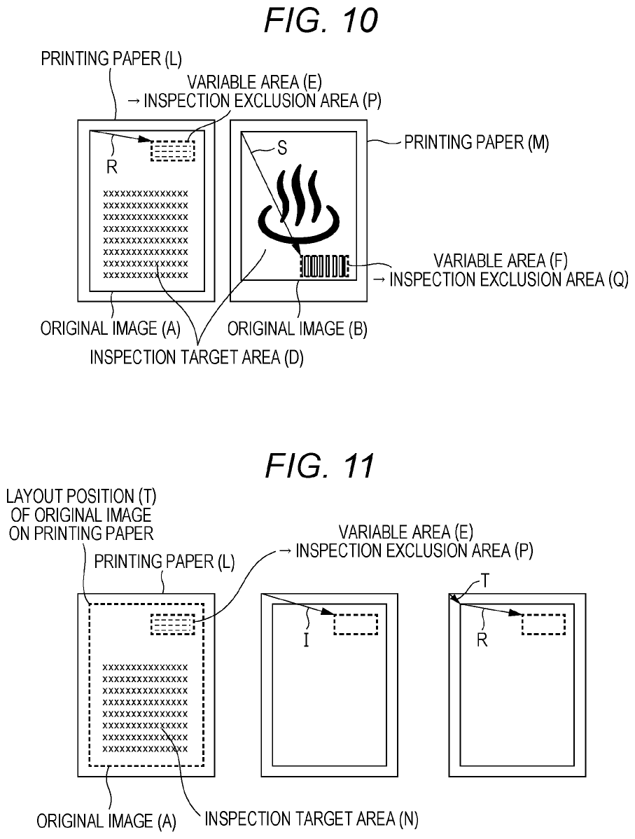

Also, as illustrated in FIG. 10, also in a case where the paper size of the paper on which the original images (A) and (B) are printed is changed (printing paper (C) is changed to printing paper (L) and printing paper (M)), the inspection exclusion areas (P) and (Q) are associated with the original image as the offset positions (R) and (S) from the upper left corner of the original image, respectively, so that the inspection exclusion areas (P) and (Q) are also changed in conjunction with the positions of the destination field (variable area (E)) and the barcode field (variable area (F)). Therefore, the destination field (variable area (E)) and the barcode field (variable area (F)) may be excluded from the inspection target without deleting the original inspection exclusion area or newly setting the inspection exclusion area.

Next, a method of associating the inspection exclusion area with the original image is described. As illustrated in FIG. 11, from a difference between a position (I) on the printing paper of the inspection exclusion area (P) designated by the inspection exclusion area designator 35 and a layout position (T) of the original image on the printing paper, the offset position (R) from the upper left corner of the original image is calculated to be stored in association with the original image. The layout position (T) of the original image on the printing paper is a printing position on the printing paper (L) of the original image (A).

For example, when coordinates on the printing paper (L) of the layout position (T) of the original image on the printing paper are (xt, yt), and coordinates on the printing paper (L) of the inspection exclusion area (P) are (xi, yi), coordinates of the offset position (R) from the upper left corner of the original image associated with the original image are obtained by (xi-xt, yi-yt).

At the time of image inspection, calculation opposite to that when obtaining the offset position (R) from the upper left corner of the original image is performed, and the offset position (I) from the upper left corner of the printing paper is calculated from the layout position (T) of the original image on the printing paper and the offset position (R) from the upper left corner of the original image, and an area designated by the offset position (I) is removed from the inspection target.

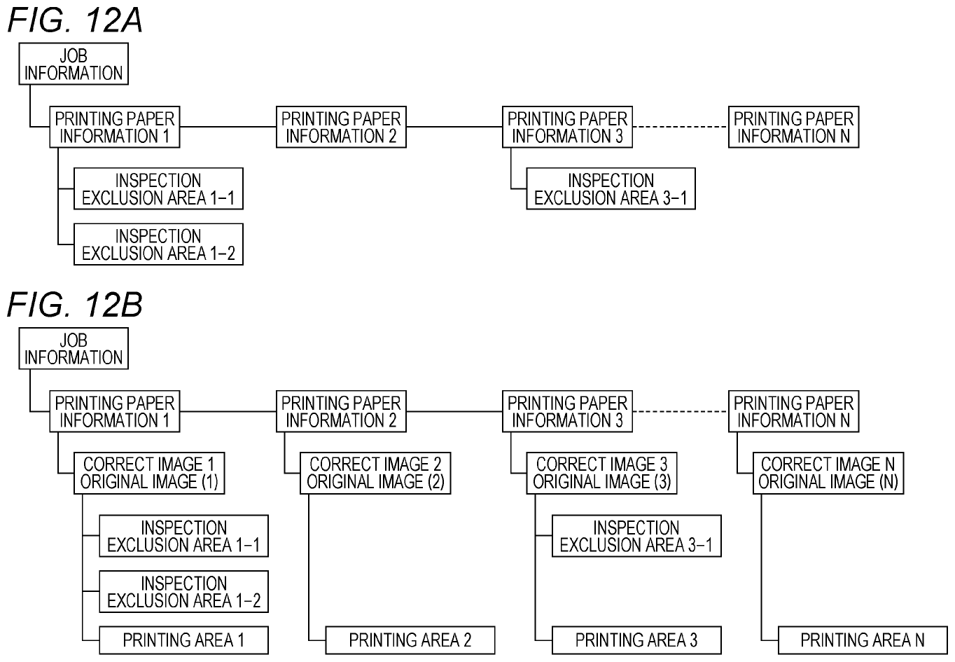

FIGS. 12A and 12B illustrate examples of print job information in a case where the correct image is the original image, in which FIG. 12A is a conventional relationship diagram and FIG. 12B is a relationship diagram of this example. As illustrated in FIG. 12A, conventionally, inspection exclusion areas 1-1 and 1-2 are managed in association with printing paper information 1, and an inspection exclusion area 3-1 is managed in association with printing paper information 3. Therefore, in a case where the layout position of the original image on the printing paper is changed, it has been necessary to newly set the inspection exclusion area.

On the other hand, in this example, as illustrated in FIG. 12B, the job information is managed in association with a plurality of pieces of printing paper information and the original image which is the correct image. For example, in a case where two inspection exclusion areas are set for the printing paper 1, an original image 1 is associated with the printing paper information 1 which is printing paper information of the printing paper 1, and the original image 1 is associated with a printing area 1, and the inspection exclusion areas 1-1 and 1-2 of the original image on the printing paper. As a result, at the time of image inspection, it is possible to calculate the offset positions from the upper left corner of the printing paper of the inspection exclusion areas from the printing area 1 of the original image on the printing paper and the inspection exclusion areas 1-1 and 1-2 associated with the original image, and the inspection exclusion area may be designated from the calculated offset positions.

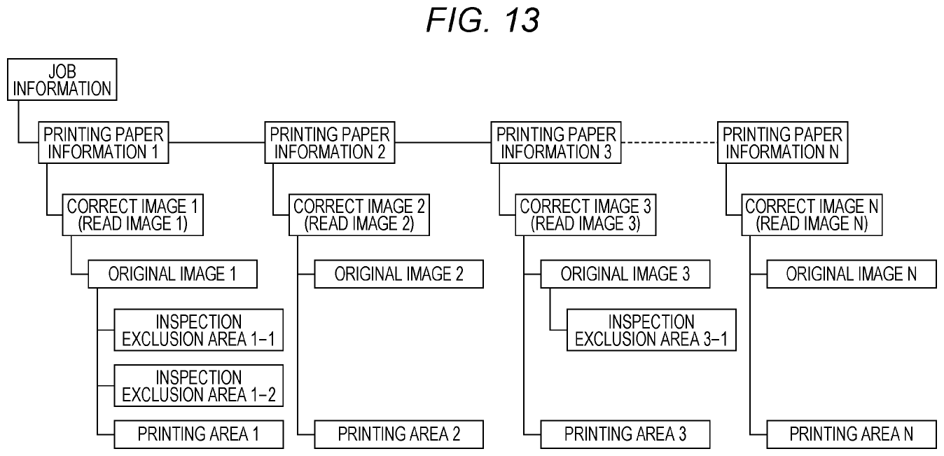

The above-described example is an example of a case where the correct image is the original image; however, in a proof mode (proof printing), the read image read by the image reading unit 39 is sometimes used as the correct image. In a case where the correct image is the read image in the proof mode, as illustrated in FIG. 13, the original image associated with the inspection exclusion area is associated with the correct image (read image in the proof mode) to be managed. As a result, at the time of image inspection, it is possible to calculate the offset positions from the upper left corner of the printing paper of the inspection exclusion areas from the printing area 1 of the original image and the inspection exclusion areas 1-1 and 1-2 associated with the original image, and the inspection exclusion areas may be designated from the calculated offset positions.

In this manner, in a case where the correct image is the read image in the proof mode, the inspection exclusion area designator 35 designates the inspection exclusion area for the read image read by the image reading unit 39, calculates the offset position from the upper left corner of the original image of the designated inspection exclusion area, and stores the same in association with the original image. On the other hand, in a case where the correct image is the original image, it is necessary to generate the printing paper image in which the original image may be discriminated in order for the inspection exclusion area designator 35 to allow the user to designate the inspection exclusion area. Therefore, the printing paper image generator 38 generates the printing paper image obtained by combining the original image with the printing area of the original image on the printing paper on an underlayer having a printing paper size. The inspection exclusion area designator 35 designates the inspection exclusion area for the printing paper image generated by the printing paper image generator 38, calculates the offset position from the upper left corner of the original image of the designated inspection exclusion area, and stores the same in association with the original image.

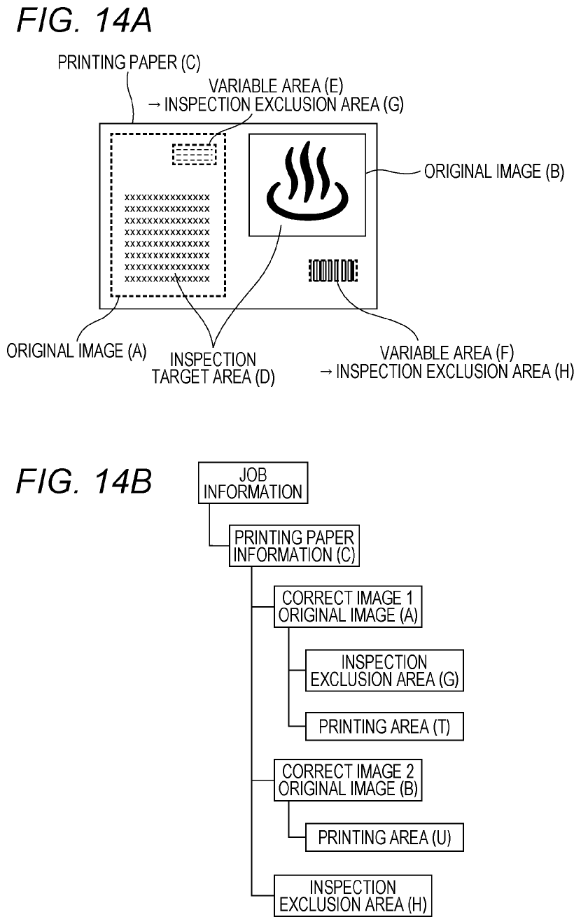

A case where the area desired to be excluded from the inspection is in the original image area is heretofore described; however, there also is a case where the area desired to be excluded from the inspection is not in the original image area as illustrated in FIG. 14A. For example, FIG. 14A illustrates a case where the barcode is printed in advance on the paper before the image formation. In a case where the user designates the barcode as the inspection exclusion area, this is not the area on the original image, so that the inspection exclusion area (H) does not overlap with the printing area of the original image on the printing paper. Therefore, in a case where the inspection exclusion area (H) is stored in association with the original image (A) or (B), if the layout of the original image is changed, the inspection exclusion area (H) associated with the original image might be laid out in a position not intended by the user.

Therefore, in a case where the inspection exclusion area does not overlap with the printing area of the original image on the printing paper, the inspection exclusion area is stored in association with the printing paper. FIG. 14B is an example of the job information in this case. Since the inspection exclusion area (G) is laid out in the printing area of the original image (A), this is stored in association with the original image (A), and since the inspection exclusion area (H) is laid out outside the original image area, this is stored in association with the printing paper information (C). As a result, the inspection exclusion area laid out outside the original image area may also be excluded from the inspection at the time of image inspection as the inspection exclusion area intended by the user.

Next, operation of the image inspection apparatus 30 of this example is described. The CPU which forms the controller 31 executes a process at each step illustrated in flowcharts in FIGS. 15 to 19 by developing an image inspection program stored in the ROM or the storage 33 on the RAM to execute. Note that the correct image is the original image.

As illustrated in FIG. 15, the controller 31 generates the correct image (S110), designates the inspection exclusion area (S120), and executes the image inspection (S130). Thereafter, the controller 31 determines whether the reprinting is instructed (S140), and in a case where the reprinting is instructed (Yes at S140), this determines whether the layout is changed (S150). In a case where the layout is not changed (No at S150), there is no need to change the inspection exclusion area, so that this returns to S130 to execute the inspection job, and in a case where the layout is changed (Yes at S150), the controller 31 changes the inspection exclusion area (S160), and thereafter returns to S130 to execute the inspection job.

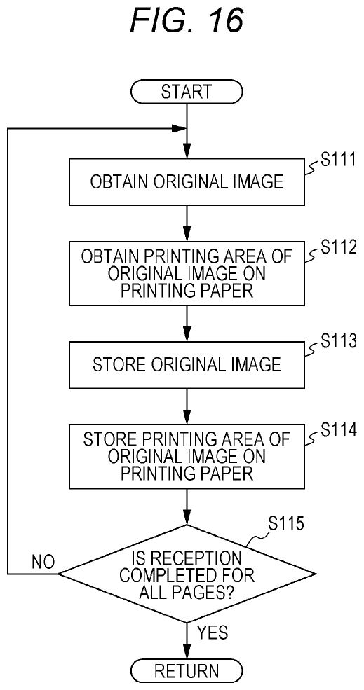

FIG. 16 illustrates a correct image generating process at S110 in FIG. 15 in detail. First, the original image obtainer 34a obtains the original image from the image forming apparatus 20 (S111). The obtained original image is stored in a page memory 1. Next, the printing area obtainer 34b obtains the printing area of the original image on the printing paper from the image forming apparatus 20 (S112). Next, the instruction unit 32 stores the original image obtained by the original image obtainer 34a in the storage 33 (S113) and stores the printing area of the original image on the printing paper obtained by the printing area obtainer 34b in the storage 33 (S114). Then, the controller 31 determines whether all the pages are received (S115), and repeatedly executes processes at S111 to S114 until all the pages are received.

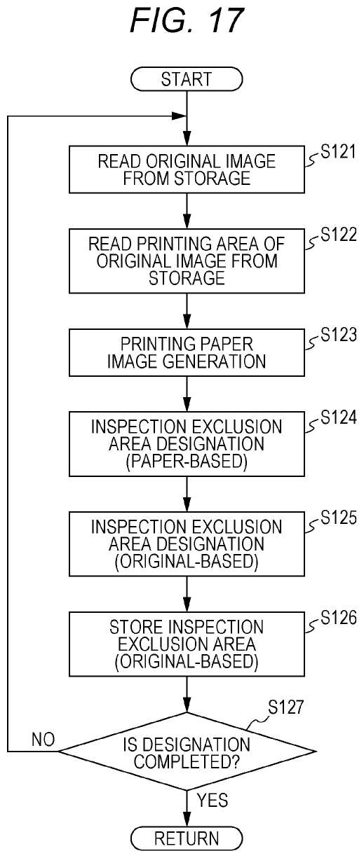

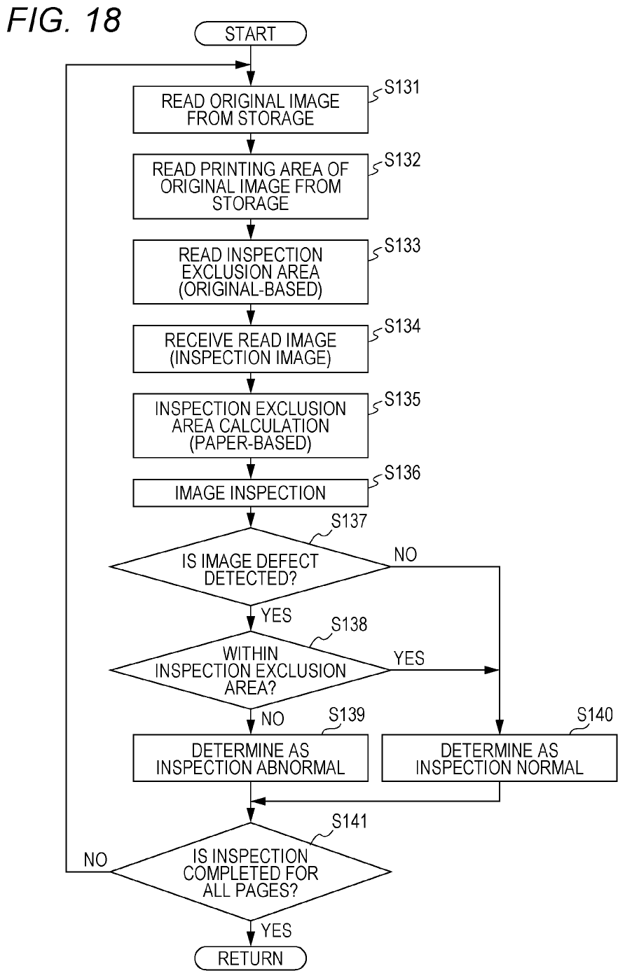

FIG. 17 illustrates an inspection exclusion area designating process at S120 in FIG. 15 in detail. First, the instruction unit 32 reads from the storage 33 the original image (S121) and reads the printing area of the original image on the printing paper (S122). Next, the instruction unit 32 instructs the printing paper image generator 38 to generate the printing paper image, and the printing paper image generator 38 combines the original image in the page memory 1, the printing area of the original image on the printing paper, and the background image of the printing paper size obtained in advance to generate the printing paper image, and stores the same in the page memory 2 (S123). Thereafter, the printing paper image generator 38 notifies the instruction unit 32 that printing paper image generation is completed. Next, the instruction unit 32 instructs the inspection exclusion area designator 35 to designate the inspection exclusion area, and the inspection exclusion area designator 35 displays the printing paper image generated by the printing paper image generator 38 to allow the user to designate the area, thereby designating the inspection exclusion area (paper-based) (S124). Thereafter, the inspection exclusion area designator 35 notifies the instruction unit 32 that the inspection exclusion area designation is completed. Next, the instruction unit 32 instructs the inspection exclusion area calculator 36 to calculate the inspection exclusion area (original-based), and the inspection exclusion area calculator 36 calculates the inspection exclusion area (original-based) from the inspection exclusion area (paper-based) designated by the inspection exclusion area designator 35 and the printing area of the original image on the printing paper (S125). Thereafter, the inspection exclusion area calculator 36 notifies the instruction unit 32 that the inspection exclusion area calculation is completed. Next, the instruction unit 32 stores the inspection exclusion area (original-based) in the storage 33 (S126). Then, the controller 31 determines whether the inspection exclusion area designation is completed (S127), and repeatedly executes the processes at S121 to S126 until the designation is completed.

FIG. 18 illustrates the image inspection at S130 in FIG. 15 in detail. First, the instruction unit 32 reads the original image from the storage 33 (S131), reads the printing area of the original image on the printing paper (S132), and reads the inspection exclusion area (paper-based) (S133). Next, the instruction unit 32 receives the read image (inspection image) obtained by reading the paper after the image formation from the image reading unit 39 and stores the same in the page memory 2 (S134). Next, the instruction unit 32 instructs the inspection exclusion area calculator 36 to calculate the inspection exclusion area (paper-based), and the inspection exclusion area calculator 36 calculates the inspection exclusion area (paper-based) from the inspection exclusion area (paper-based) and the printing area of the original image on the printing paper (S135). Thereafter, the inspection exclusion area calculator 36 notifies the instruction unit 32 that the inspection exclusion area calculation is completed. Next, the instruction unit 32 instructs the image inspector 37 to inspect the image, and the image inspector 37 performs the image inspection using the original image (page memory 1) and the read image (page memory 2) (S136). Then, the image inspector 37 determines whether the image defect is detected (S137), and in a case where the image defect is detected (Yes at S137), this determines whether the image defect is within the inspection exclusion area (S138). In a case where the image defect is not within the inspection exclusion area (No at S138), the image inspector 37 determines as inspection abnormal and notifies the instruction unit 32 of the same (S139), and in a case where no image defect is detected (No at S137) or the image defect is outside the inspection exclusion area (Yes at S138), the image inspector 37 determines as inspection normal and notifies the instruction unit 32 of the same (S140). Then, the controller 31 determines whether all page inspection is completed (S141), and repeatedly executes the processes at S131 to S140 until the inspection of all the pages is completed.

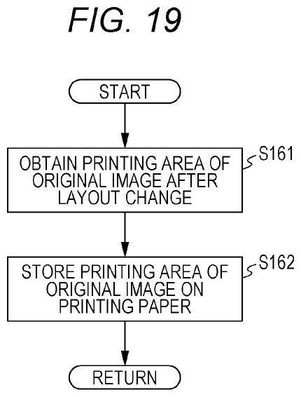

FIG. 19 illustrates an inspection exclusion area changing process at S160 in FIG. 15 in detail. When the image forming apparatus 20 changes the layout on the printing paper of the original image, the printing area obtainer 34b obtains the printing area of the original image on the printing paper after the layout change from the image forming apparatus 20 and notifies the instruction unit 32 of the same (S161), and the instruction unit 32 stores the printing area of the original image on the printing paper after the layout change in the storage 33 (S162).

As described above, by setting the inspection exclusion area based on the original image, even in a case where the layout of the original image is changed or an image forming condition is changed at the time of reprinting, the image inspection may be performed on an appropriate area.

### EXAMPLE 2

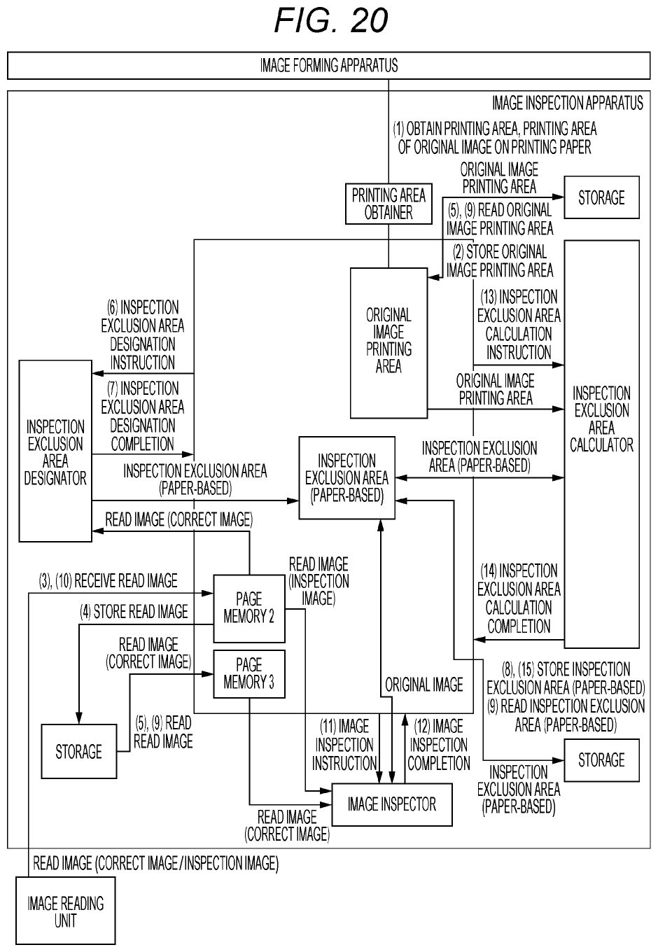

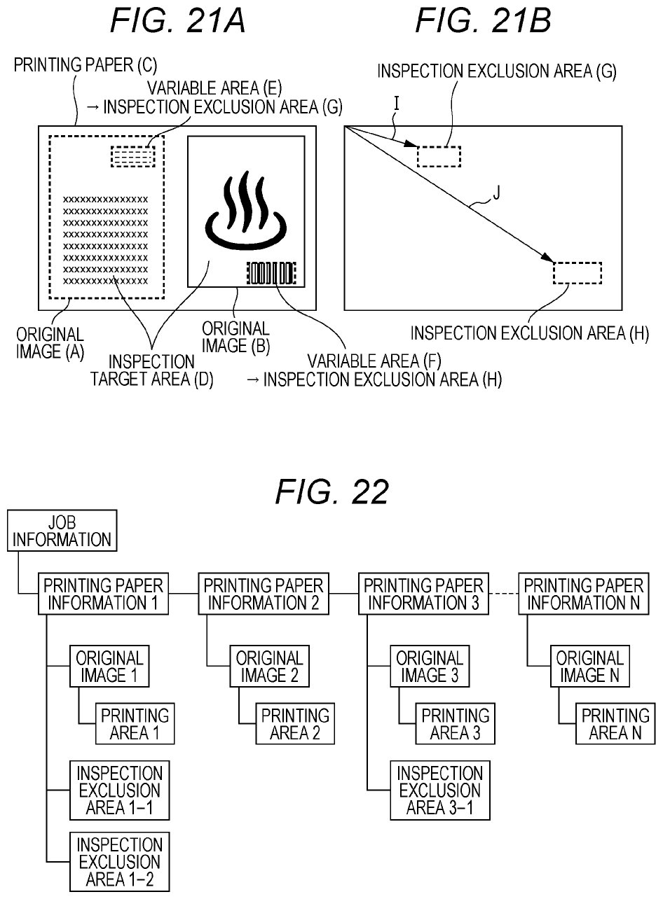

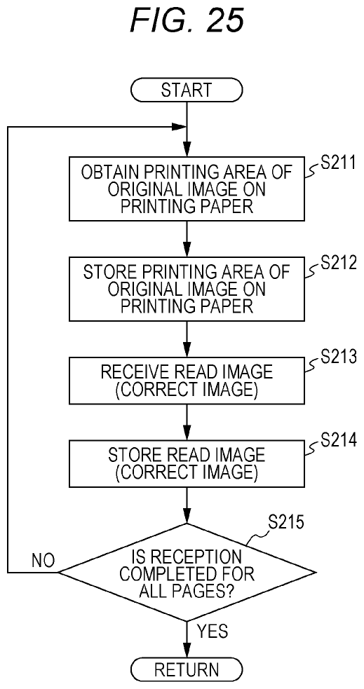

Next, an image inspection apparatus, an image inspection method, and an image inspection program according to a second example of the present invention are described with reference to FIGS. 20 to 28. FIG. 20 is a schematic diagram illustrating a process of the image inspection apparatus. FIGS. 21A to 24 are schematic diagrams for describing a method of designating an inspection exclusion area according to this example, and FIGS. 25 to 28 are flowcharts illustrating operation of the image inspection apparatus according to this example.

In the first example described above, the inspection exclusion area is set based on an original image, but it is also possible to set the inspection exclusion area based on a printing area of an original image on printing paper. In this case, a configuration of an image inspection apparatus 30 is similar to that in FIG. 6 of the first example, but a storage 33 stores the inspection exclusion area in association with printing paper information of job information.

An inspection exclusion area designator 35 designates the inspection exclusion area on the printing paper on a read image obtained by reading the printing paper after an image is formed thereon by an image reading unit 39 and associates the designated inspection exclusion area on the printing paper with the image obtained by reading the printing paper after the image formation to store in the storage 33 and the like. For example, by allowing a display operation unit (for example, a touch panel 23 of an image forming apparatus 20 and the like) in an image inspection system 10 to display the read image, allowing a user to designate the area, and obtaining area designating operation information from the display operation unit, the inspection exclusion area on the printing paper is designated.

In a case where the printing area of the original image on the printing paper is changed, an inspection exclusion area calculator 36 changes the inspection exclusion area on the printing paper based on the inspection exclusion area on the printing paper designated by the inspection exclusion area designator 35 and a difference between the printing area of the original image on the printing paper before the change of the printing area and that after the change and stores the changed inspection exclusion area on the printing paper in the storage 33 and the like. At that time, the inspection exclusion area calculator 36 determines whether the inspection exclusion area on the printing paper overlaps with the changed printing area of the original image on the printing paper, and changes the inspection exclusion area on the printing paper overlapping with the printing area of the original image on the printing paper.

Hereinafter, a process of the image inspection system 10 configured as described above is described with reference to FIG. 20. Note that, FIG. 20 illustrates the process in a case where a correct image is the read image.

<Correct Image Generation>

(1) A printing area obtainer 34b obtains the printing area of the original image on the printing paper from the image forming apparatus 20.

(2) The instruction unit 32 stores the printing area of the original image on the printing paper obtained by the printing area obtainer 34b in the storage 33.

(3) The instruction unit 32 receives the read image (correct image) obtained by reading the printing paper after the image formation, and stores the same in a page memory 2.

(4) The instruction unit 32 stores the read image (correct image) obtained by reading the printing paper after the image formation in the storage 33.

<Inspection Exclusion Area Designation>

(5) The instruction unit 32 reads from the storage 33 the printing area of the original image on the printing paper and the read image (correct image).

(6) The instruction unit 32 instructs the inspection exclusion area designator 35 to designate the inspection exclusion area.

(7) The inspection exclusion area designator 35 designates the inspection exclusion area (paper-based) for the read image (correct image) (page memory 3). Then, the inspection exclusion area designator 35 notifies the instruction unit 32 that the inspection exclusion area designation is completed.

(8) The instruction unit 32 stores the inspection exclusion area (paper-based) designated by the inspection exclusion area designator 35 in the storage 33.

<Image Inspection>

(9) The instruction unit 32 reads the read image (correct image), the printing area of the original image on the printing paper, and the inspection exclusion area (paper-based) from the storage 33.

(10) The instruction unit 32 receives the read image (inspection image) obtained by reading the paper after the image formation, and stores the same in the page memory 2.

(11) The instruction unit 32 instructs the image inspector 37 to inspect the image.

(12) The image inspector 37 performs the image inspection using the read image (correct image) (page memory 3) and the read image (inspection image) (page memory 2). At that time, the inspection exclusion area (paper-based) designated by the inspection exclusion area designator 35 is excluded from the inspection (even when abnormality is detected in the inspection exclusion area, this is not determined as abnormal). Then, the image inspector 37 notifies the instruction unit 32 that the image inspection is completed.

<Process in Case where Layout of Original Image on Printing Paper is Changed>

(13) The instruction unit 32 instructs the inspection exclusion area calculator 36 to calculate the inspection exclusion area.

(14) The inspection exclusion area calculator 36 determines whether the inspection exclusion area (paper-based) overlaps with the printing area of the original image on the printing paper after the layout change. In a case where it is determined that they overlap with each other, the inspection exclusion area (paper-based) is calculated based on a difference between the printing area of the original image on the printing paper before the layout change and the printing area of the original image on the printing paper after the layout change. Then, the inspection exclusion area calculator 36 notifies the instruction unit 32 that the inspection exclusion area calculation is completed.

(15) The instruction unit 32 stores the inspection exclusion area (paper-based) calculated by the inspection exclusion area calculator 36 in the storage 33.

Thereafter, the procedure shifts to <Image inspection> and a similar process is performed. At that time, since the inspection exclusion area on the printing paper is stored in the storage 33 in (15) above, the process in <Inspection exclusion area designation> is unnecessary.

Hereinafter, the method of designating the inspection exclusion area according to this example is specifically described with reference to the drawings. When original images (A) and (B) illustrated in FIGS. 1A to 1C are printed on printing paper (C), as illustrated in FIG. 21A, a destination field (variable area (E)) and a barcode field (variable area (F)) are designated as inspection exclusion areas (G) and (H) as areas excluded from an inspection target. At that time, in this example, as illustrated in FIG. 21B, the designated inspection exclusion areas (G) and (H) are stored in association with the printing paper (C) (stored as offset positions (I) and (J) from an upper left corner of the printing paper). The steps so far are the same as those in the conventional art, but in this example, as illustrated in FIG. 22, the printing paper information is associated with the original image formed on the printing paper and the printing area of the original image on the printing paper to be stored.

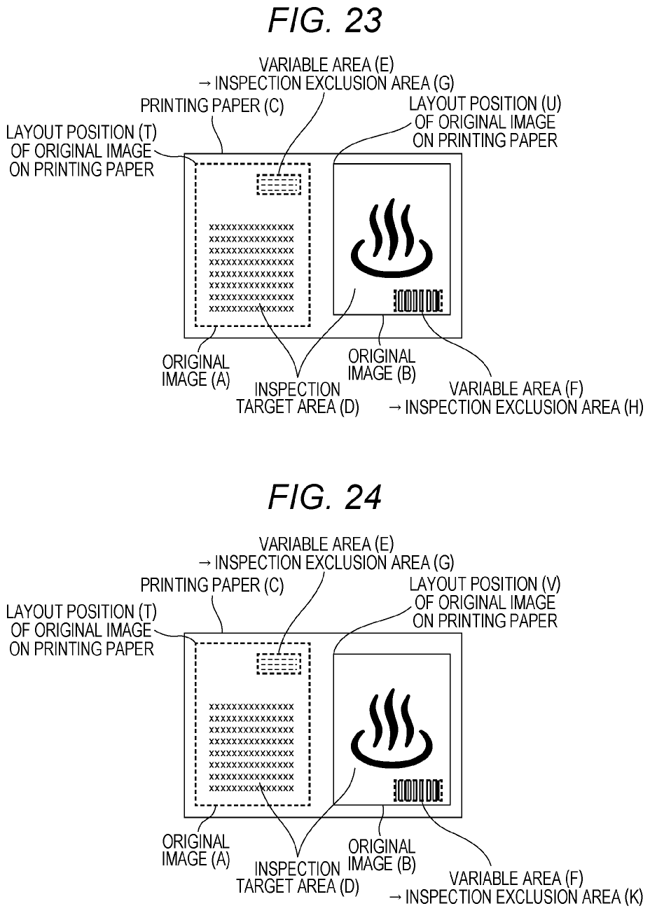

A method of calculating the inspection exclusion area in a case where the printing area of the original image on the printing paper is changed is described with reference to FIGS. 23 and 24. FIGS. 23 and FIG. 24 illustrate examples in which the layout of the original image (B) is changed to a position shifted downward. The inspection exclusion area (H) in a case where the printing area of the original image is changed is described; it is determined whether the inspection exclusion area (H) before the layout change overlaps with all the original images laid out on the printing paper. In this case, the inspection exclusion area (H) does not overlap with the printing area of the original image (A) on the printing paper, but overlaps with the printing area of the original image (B) on the printing paper.

Next, it is determined whether the layout of the overlapping original images is changed. In this case, since the layout of the original image (B) overlapping with the inspection exclusion area (H) is changed, an inspection exclusion area (K) which is the area after the inspection exclusion area (H) is changed is calculated.

Specifically, when a printing area (U) of the original image (B) on the printing paper before the layout change is set to (xu, yu), an inspection exclusion area (H) on the printing paper before the layout change is set to (xh, yh), a printing area (V) of the original image (B) on the printing paper after the layout change is (xv, yv), and the inspection exclusion area (K) on the printing paper after the layout change is (xk, yk), the inspection exclusion area (K) (xk, yk) may be obtained by moving the inspection exclusion area (H) on the printing paper by an amount of movement of the layout position of the original image (B) on the printing paper as described in the following equation,

(xk, yk)=(xh, yh)+(xv−xu, yv−yu) (2)

Next, operation of the image inspection apparatus 30 of this example is described. A CPU which forms a controller 31 executes a process at each step illustrated in flowcharts in FIGS. 25 to 28 by developing an image inspection program stored in a ROM or the storage 33 on a RAM to execute. Note that the correct image is the read image. Since an entire process in FIG. 15 is similar to that of the first example, description thereof is omitted.

FIG. 25 illustrates a correct image generating process at S110 in FIG. 15 in detail. First, the printing area obtainer 34b obtains the printing area of the original image on the printing paper from the image forming apparatus 20 (S211). Next, the instruction unit 32 stores the printing area of the original image on the printing paper obtained by the printing area obtainer 34b in the storage 33 (S212). Next, the instruction unit 32 receives the image (correct image) obtained by reading the printing paper after the image formation, stores the same in the page memory 2 (S213), and stores sore the same in the storage 33 (S214). Then, the controller 31 determines whether all pages are received (S215), and repeatedly executes the processes at S211 to S214 until all the pages are received.

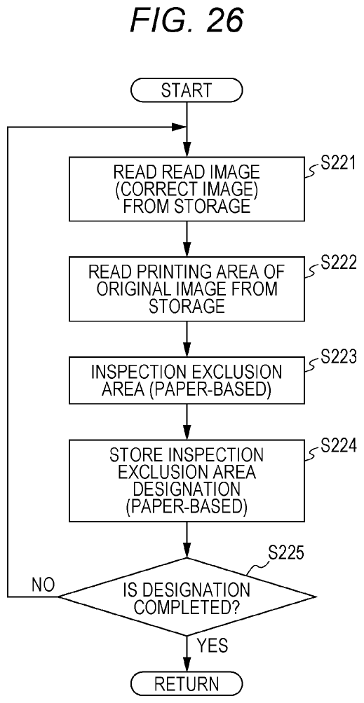

FIG. 26 illustrates an inspection exclusion area designating process at S120 in FIG. 15 in detail. First, the instruction unit 32 reads the read image (correct image) from the storage 33 (S221), and reads the printing area of the original image on the printing paper (S222). Next, the instruction unit 32 instructs the inspection exclusion area designator 35 to designate the inspection exclusion area, and the inspection exclusion area designator 35 displays the read image (correct image) (page memory 3) to allow the user to designate the area, thereby designating the inspection exclusion area (paper-based) (S223). Thereafter, the inspection exclusion area designator 35 notifies the instruction unit 32 that the inspection exclusion area designation is completed. Next, the instruction unit 32 stores the inspection exclusion area (paper-based) designated by the inspection exclusion area designator 35 in the storage 33 (S224). Then, the controller 31 determines whether the inspection exclusion area designation is completed (S225), and repeatedly executes the processes at S221 to S224 until the designation is completed.

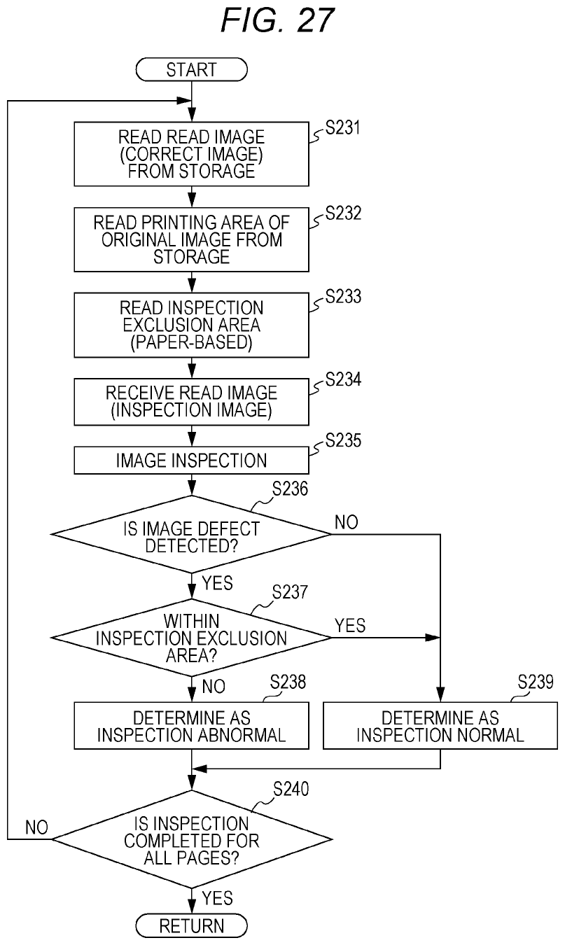

FIG. 27 illustrates the image inspection at S130 in FIG. 15 in detail. First, the instruction unit 32 reads the read image (correct image) from the storage 33 (S231), reads the printing area of the original image on the printing paper (S232), and reads the inspection exclusion area (paper-based) (S233). Next, the instruction unit 32 receives the read image (inspection image) obtained by reading the printing paper after the image formation, and stores the same in the page memory 2 (S234). Next, the instruction unit 32 instructs the image inspector 37 to inspect the image, and the image inspector 37 performs the image inspection using the read image (correct image) and the read image (inspection image) (S235). Then, the image inspector 37 determines whether an image defect is detected (S236), and in a case where the image defect is detected (Yes at S236), this determines whether the image defect is within the inspection exclusion area (S237). In a case where the image defect is not within the inspection exclusion area (No at S237), the image inspector 37 determines as inspection abnormal and notifies the instruction unit 32 of the same (S238), and in a case where no image defect is detected (No at S236) or the image defect is within the inspection exclusion area (Yes at S237), the image inspector 37 determines as inspection normal and notifies the instruction unit 32 of the same (S239). Then, the controller 31 determines whether the inspection is completed for all the pages (S240), and repeatedly executes processes at S231 to S239 until the inspection is completed for all the pages.

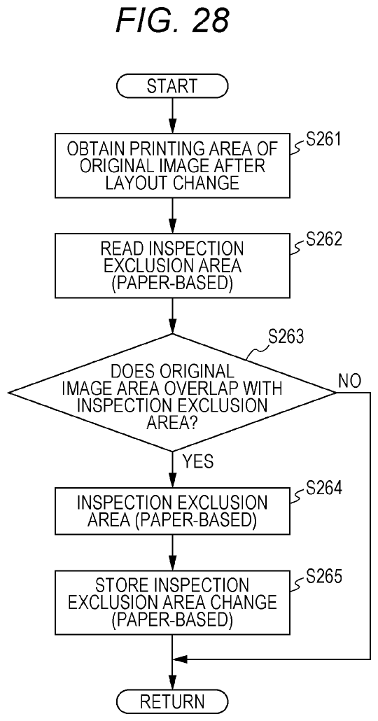

FIG. 28 illustrates the inspection exclusion area changing process at S160 in FIG. 15 in detail. When the image forming apparatus 20 changes the layout on the printing paper of the original image, the printing area obtainer 34b obtains the printing area of the original image on the printing paper after the layout change from the image forming apparatus 20 (S261). Next, the instruction unit 32 reads the inspection exclusion area (paper-based) from the storage 33 (S262). Next, the instruction unit 32 instructs the inspection exclusion area calculator 36 to calculate the inspection exclusion area (paper-based), and the inspection exclusion area calculator 36 determines whether the inspection exclusion area (paper-based) overlaps with the printing area of the original image on the printing paper after the layout change (S263). In a case where it is determined that they overlap with each other (Yes at S263), the inspection exclusion area calculator 36 changes the inspection exclusion area (paper-based) based on the difference between the printing area of the original image on the printing paper before the layout change and that after the layout change (S264) and notifies the instruction unit 32 that the inspection exclusion area calculation is completed. Then, the instruction unit 32 stores the changed inspection exclusion area (paper-based) in the storage 33 (S265).

As described above, even in a case where the inspection exclusion area is set based on the printing paper, by storing the original image and the printing area of the original image on the printing paper in association with the printing paper, and changing the inspection exclusion area based on the difference in the printing area of the original image on the printing paper before the layout change and that after the layout change, even in a case of changing the layout of the original image or changing an image forming condition at the time of reprinting, the image inspection may be performed on an appropriate area.

Note that the present invention is not limited to the above-described example, and the configuration and control thereof may be appropriately changed without departing from the gist of the present invention.

For example, although the image inspection system 10 in which the image forming apparatus 20 and the image inspection apparatus 30 are integrally formed is described in the above-described example, the image inspection method of the present invention may be similarly applied to a case where the image inspection apparatus 30 is operated alone. In that case, the image forming apparatus 20 and the image inspection apparatus 30 may be connected so as to be communicable, and the image inspection apparatus 30 may be provided with a display operation unit such as a touch panel for allowing the user to designate the inspection exclusion area.

The present invention is applicable to an image inspection apparatus which inspects a read image obtained by reading an original image formed on printing paper, an image inspection method using the image inspection apparatus, an image inspection program which operates on the image inspection apparatus, and a recording medium in which the image inspection program is recorded.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An image inspection apparatus, comprising:
a central processing unit (CPU) that inspects an image obtained by reading a printing paper after image formation in which an original image is laid out on the printing paper and an image is formed by an image forming apparatus,
obtains a printing area of the original image on the printing paper,
designates an inspection exclusion area on the printing paper, and
in response to a change in the printing area of the original image on the printing paper, changes the inspection exclusion area on the printing paper based on the change in the printing area.

2. The image inspection apparatus according to claim 1, wherein the CPU further:
calculates an inspection exclusion area on the original image based on the inspection exclusion area on the printing paper and the printing area of the original image on the printing paper, and
stores the calculated inspection exclusion area on the original image in association with the original image.

3. The image inspection apparatus according to claim 2, wherein, in response to the change in the printing area of the original image on the printing paper, the CPU further:
calculates the inspection exclusion area on the printing paper based on the inspection exclusion area on the original image stored in the CPU and the printing area of the original image on the printing paper obtained after the change by the CPU, and
excludes the calculated inspection exclusion area on the printing paper from the inspection.

4. The image inspection apparatus according to claim 2, wherein the CPU further:
determines whether the inspection exclusion area on the printing paper overlaps with the printing area of the original image on the printing paper, and
stores the inspection exclusion area on the printing paper that does not overlap with the printing area of the original image on the printing paper in association with the printing paper.

5. The image inspection apparatus according to claim 1, wherein the CPU further stores the inspection exclusion area on the printing paper in association with the image obtained by reading the printing paper after the image formation.

6. The image inspection apparatus according to claim 5, wherein, in response to the change in the printing area of the original image on the printing paper, the CPU further:
changes the inspection exclusion area on the printing paper based on the inspection exclusion area on the printing paper stored in the CPU and a difference in the printing area of the original image on the printing paper obtained before and after the change by the CPU, and
stores the changed inspection exclusion area on the printing paper.

7. The image inspection apparatus according to claim 6, wherein the CPU further:
determines whether the inspection exclusion area on the printing paper overlaps with the printing area of the original image on the printing paper after the change, and
changes the inspection exclusion area on the printing paper that overlaps with the printing area of the original image on the printing paper.

8. The image inspection apparatus according to claim 1, wherein the CPU further:
obtains the original image,
generates a printing paper image based on the original image and the printing area of the original image on the printing paper, and
designates the inspection exclusion area on the printing paper image.

9. The image inspection apparatus according to claim 1, wherein the CPU further designates the inspection exclusion area on the image obtained by reading the printing paper after the image formation.

10. An image inspection method in an image inspection apparatus that executes inspecting an image obtained by reading printing paper after image formation in which an original image is laid out on the printing paper and an image is formed by an image forming apparatus, the image inspection method comprising:
obtaining a printing area of the original image on the printing paper;
designating an inspection exclusion area on the printing paper; and
in response to a change in the printing area of the original image on the printing paper, changing the inspection exclusion area on the printing paper based on the change in the printing area.

11. The image inspection method according to claim 10, further comprising:
calculating an inspection exclusion area on the original image based on the inspection exclusion area on the printing paper and the printing area of the original image on the printing paper; and
storing the calculated inspection exclusion area on the original image in association with the original image.

12. The image inspection method according to claim 11, wherein, further comprising:
in response to the change in the printing area of the original image on the printing paper:
calculating the inspection exclusion area on the printing paper based on the inspection exclusion area on the original image stored in the CPU and the printing area of the original image on the printing paper obtained after the change, and
excluding the calculated inspection exclusion area on the printing paper is excluded from the inspection.

13. The image inspection method according to claim 11, further comprising:
determining whether the inspection exclusion area on the printing paper overlaps with the printing area of the original image on the printing paper; and
storing the inspection exclusion area on the printing paper that does not overlap with the printing area of the original image on the printing paper in association with the printing paper.

14. The image inspection method according to claim 10, further comprising storing the inspection exclusion area on the printing paper in association with the image obtained by reading the printing paper after the image formation.

15. The image inspection method according to claim 14, further comprising:
in response to a change in the printing area of the original image on the printing paper:
changing the inspection exclusion area on the printing paper is changed based on the inspection exclusion area on the printing paper stored in the CPU and a difference in the printing area of the original image on the printing paper obtained before and after the change, and
the CPU stores the changed inspection exclusion area on the printing paper.

16. The image inspection method according to claim 15, further comprising:
determining whether the inspection exclusion area on the printing paper overlaps with the printing area of the original image on the printing paper after the change; and
changing the inspection exclusion area on the printing paper that overlaps with the printing area of the original image on the printing paper.

17. The image inspection method according to claim 10, further comprising:
obtaining the original image; and
generating a printing paper image based on the original image and the printing area of the original image on the printing paper, wherein
in the designating, the inspection exclusion area is designated on the printing paper image.

18. The image inspection method according to claim 10, further comprising designating the inspection exclusion area on the image obtained by reading the printing paper after the image formation.

19. A non-transitory recording medium storing a computer readable image inspection program operating in an image inspection apparatus that executes inspecting an image obtained by reading printing paper after image formation in which an original image is laid out on the printing paper and an image is formed by an image forming apparatus, the image inspection program allowing a central processing unit (CPU) of the image inspection apparatus to execute:
obtaining a printing area of the original image on the printing paper;
designating an inspection exclusion area on the printing paper; and
in response to a change in the printing area of the original image on the printing paper, changing the inspection exclusion area on the printing paper based on the change in the printing area.
